(19) United States
(12) Patent Application Publication
(10) Pub. No.: US 2014/0059620 A1
(43) Pub. Date: Feb. 27, 2014

(54) VIDEO BUFFER MANAGEMENT TECHNIQUE

(71) Applicant: Steven Charles Rhoads, Carmel, IN (US)

(72) Inventor: Steven Charles Rhoads, Carmel, IN (US)

(73) Assignee: THOMSON LICENSING, Issy de Mculineaux (FR)

(21) Appl. No.: 14/113,831

(22) PCT Filed: Apr. 27, 2012
(86) PCT No.: PCT/US12/35332

§ 371 Date: Oct. 25, 2013

Related U.S. Application Data
(60) Provisional application No. 61/480,085, filed on Apr. 28, 2011.

(51) Int. Cl. H04N 7/20; H04H 40/90; H04H 20/74

(52) U.S. Cl. CPC H04N 7/20; H04H 20/74; H04H 40/90
USPC 725/67

(57) ABSTRACT

The video data buffering apparatus and associated methods provide audio and video data buffering in a video processing device. Specifically, the system relates to the use of a circular buffer and linked list FIFO employed in a video processing system, wherein video data packets from multiple video streams are stored in a common buffer to compensate for transport packet jitter. The apparatus and methods enable the system to store multiple QAM video stream packets in a common memory buffer. Linked list FIFOS are generated to identify the packets and their location within the common memory buffer. The linked list information is used to transfer the data between the common memory buffer and a modulator.

### PRIORITY CLAIM

This application claims the benefit of U.S. Provisional Patent Application No. 61/480,085, filed Apr. 28, 2011, entitled “Buffer Management Technique to Reduce Memory to Handle MPEG2 Transport Packet Jitter,” which is incorporated herein by reference.

### FIELD OF THE INVENTION

The present invention relates to data buffering in a video processing system. Specifically, the system relates to the use of a circular buffer and linked list FIFO employed in a video processing system, wherein video data packets from multiple video streams are stored in a common buffer to compensate for transport packet jitter.

### BACKGROUND OF THE INVENTION

The delivery of digital television signals is continuously being expanded to encompass more transmission modes. Often a large number of signals need to be converted from one format to another, such as in the case with satellite signals being converted to digital cable formats in order to transmit these signals over a closed circuit television system. This system may be in an apartment building, a sports stadium, a hotel, or the like. Further, additional video streams may originate from other sources, such as over the air broadcast, internet, or facility generated information. Facility generated information may contain information of relevance to occupants of the apartment building or sports stadium. The system may typically be required to support 12 QAM streams with 12 video channels per QAM stream. Each of the video channels can have a bitrate of 20 Mbps.

A problem exists in that each program stream must be buffered to compensate for packet jitter. Packet jitter is the delay between packets, which adversely affects the modulation and continuity of the signal. If jitter is not compensated for, a modulator may miss packets sent with not enough time in between, or may excessively wait for the next packet, and therefore disrupt the video signal. To compensate for jitter, buffers are used for queuing the packets so that a continuous play out can be transmitted. With a large number of signals, an excessively large amount of memory is required to buffer each of the video signals for the maximum required amount of time. Each of the 144 video channels typically requires 500 ms of jitter that must be buffered.

To compensate for video channel jitter, previous systems used a separate FIFO buffer for each channel. In the exemplary 144 video channel system, 180 MB would be required to provide sufficient buffering. This presents a serious design problem for the typical system having only 64 MB of DDR memory. Furthermore, using a separate FIFO for each channel requires that every packet be copied into the FIFO and then copied out of the FIFO to the modulator. It would be desirable to provide sufficient jitter buffer with the minimum amount of memory required and the minimum processor operations.

### SUMMARY OF THE INVENTION

In one aspect, the present invention involves a video signal processing apparatus comprising an input processor for receiving a video data, said video data corresponding to a plurality of video channels, a memory for storing said video data, a plurality of linked lists, wherein each of said linked lists comprises at least one identifier and one location corresponding to at least one of said plurality of video channels, a plurality of video modulators, and a controller for reading one of said plurality of linked lists, locating and identifying a portion of said video data corresponding to a single video channel in response to information from said one of said plurality of linked lists, and coupling said portion of said video data to one of said plurality of video modulators.

In another aspect, the invention also involves a method of processing video data comprising the steps of receiving data corresponding to a plurality of video channels, storing said data, generating a linked list wherein said linked list identifies said data and a location of said data, locating said data using information from said linked list, identifying said data using information from said linked list, coupling said data between a memory and a modulator, modulating said data to generate a modulated video channel, and transmitting said modulated video channel.

In another aspect, the present invention also involves a video processing apparatus comprising a plurality of inputs for receiving a plurality of video signals, a processor for converting said plurality of video signals into a plurality of packetized video signals, a memory for storing said plurality of packetized video signals, a linked list for identifying and locating each of said plurality of packetized video signals, a controller for using said linked list to couple one of said packetized video signals to a modulator to generate a modulated video signal, and an output for transmitting said modulated video signal.

### BRIEF DESCRIPTION OF THE DRAWINGS

FIG. 1 is a block diagram of an exemplary embodiment of a digital satellite broadcast system;

FIG. 2 is a block diagram of a satellite gateway system;

FIG. 3 is a block diagram of an exemplary embodiment of a gateway modulator according to the present invention;

FIG. 4 is a flowchart that illustrates a video buffering method according to the present invention.

### DETAILED DESCRIPTION OF THE PREFERRED EMBODIMENT

The characteristics and advantages of the present invention will become more apparent from the following description, given by way of example. The exemplifications set out herein illustrate preferred embodiments of the invention, and such exemplifications are not to be construed as limiting the scope of the invention in any manner. For example, one embodiment of the present invention may be included within an integrated circuit, while another embodiment of the present invention may comprise discrete elements forming a circuit.

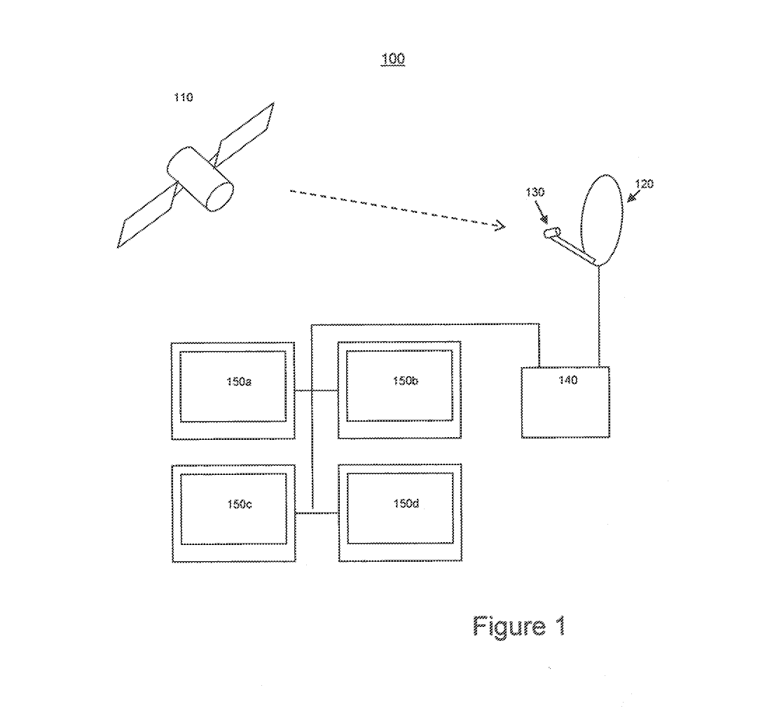

Referring to FIG. 1, a diagram of an exemplary embodiment of a satellite television system is shown. FIG. 1 shows a transmitting satellite 110, a parabolic dish antenna 120 with a low noise block 130, a digital satellite gateway 140 and a plurality of television monitors 150a-d.

A satellite broadcast system operates to broadcast microwave signals to a wide broadcast area. In a digital television broadcast system, this is accomplished by transmitting the signals from a geosynchronous satellite 110. A geosynchronous satellite 110 orbits the earth once each day and sits at approximately 35,786 kilometers above the earth's surface. Since a digital television broadcast satellite 110 generally orbits around the equator it constantly remains in the same position with respect to positions on the ground. This allows a satellite receiving antenna 120 to maintain a fixed look angle.

A digital television transmitting satellite 110 receives a plurality of signals from an uplink transmitter and then rebroadcasts the signal back to earth. The altitude of the transmitting satellite 110 allows subscribers in a wide geographical area to receiving the signal. However, the distance from the earth and the severe power conservation requirements of the satellite also result in a weak signal being received by the subscriber. It is therefore critical that the signal be amplified as soon as possible after it is received by the antenna. This requirement is achieved through the placement of a low noise block (LNB) 130 at the feed horn of the parabolic dish antenna 120.

The LNB 130 converts the signals to a format conducive to transmission over a closed link transmission means, such as a coaxial cable or an Ethernet cable. These signals are then conducted to the digital satellite gateway (140). The digital satellite gateway (140) converts some or all of the signals to a second format to be conducted over a local network. This may be a coaxial cable network, Ethernet network, or another format of network. The signal is conducted to the individual viewing positions, where it can be tuned by a television (150 a-d) or a set top box. The television or set top box may send requests to the satellite gateway (140) in order to request channels, programming, stored programming, or other audio/video programming.

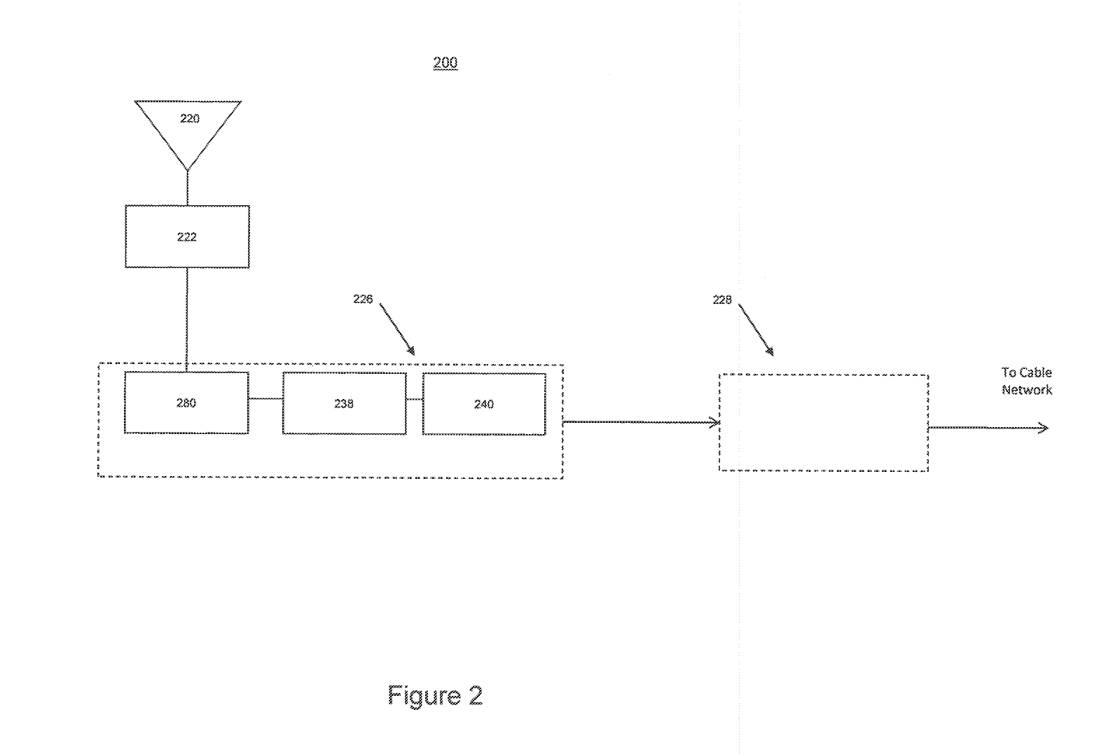

FIG. 2 is a block diagram of an exemplary satellite gateway (200) according to the present invention. System (200) primarily comprises an antenna (220), a gateway demodulator (226) and gateway modulator (228) for together receiving and digitizing a broadcast carrier modulated with signals carrying audio, video, and associated data. In more complex installations, the antenna (200) may be used in conjunction with a single-wire multi-switch (SWM) (222) to multiplex signals from multiple LNBs and their multiple polarities onto a single coaxial cable for delivery to the gateway. The SWM (222) may block convert one or more of the satellite signals polarizations to a different frequency band, thereby facilitating the transmission of a plurality of polarizations and frequency bands on the same coaxial cable. For example, the SWM (222) may convert signals from one of the satellite antennas LNBs to one of 9 designated frequency slots. Signals within these 9 frequency slots are then conducted from the SWM (222) to the gateway demodulator block (226) simultaneously.

The gateway modulator block (226) comprises one or more demodulators (280) for demodulating the received satellite signals into MPEG2 video streams. The MPEG2 video streams are then transmitted to a Packet identifier Selector (238). PID selector (238) identifies and routes selected packets in the transport stream from demodulator (280) to single program transport formatter (240). The single program transport formatter (240) is operative to merge packet from multiple PIDS, add control information, and set up the MPEG2 transport packets. Multiple MPEG2 transport packets are then placed in UDP packets in a format suitable for transmission on an Ethernet network.

The UDP packets are coupled to the gateway modulator block (228) via an Ethernet local area network, either wired or wirelessly. The gateway modulator block (228) is operative to receive the MPEG2 data, as well as any other desired data coupled via the network, and convert this data to cable channel video streams. These video streams are then coupled to televisions or set top boxes according to a coaxial cable for example, or a cable transmission network. Alternatively, the gateway modulator block (228) could be coupled to a radio frequency transmitter to enable wireless transmission of the video streams to televisions or set top boxes according to NTSC, ATSC, or other broadcast television standards.

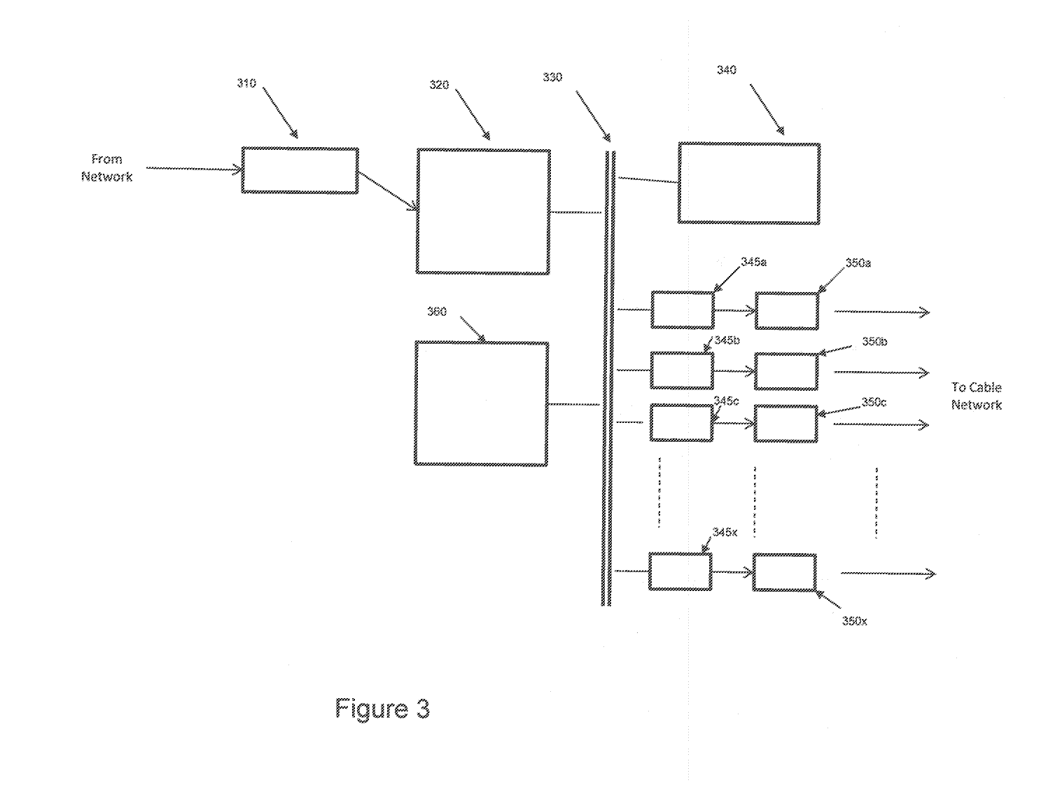

Turning now to FIG. 3, an exemplary embodiment of a gateway modulator (300) according to the present invention is shown. The gateway modulator (300) comprises an Ethernet DMA (310), a circular buffer memory (320), a data bus (330), a data bus DMA (360), a microprocessor (340), a plurality of modulators (350a-350x) and a plurality of modulator FIFOs (355a-350x). Any number of modulators and modulator FIFOs can be handled, and is only limited by system design and performance. Additional, while the same number of modulators and modulator FIFOs are shown in this exemplary embodiment, as system could be constructed where a modulator will handle more than one video stream and therefore be paired with more than one modulator FIFO. For example, a modulator could be used to modulate two video channels. These channels could be subchannels of same QAM stream, or different QAM streams using the appropriate data buffering to enable to modulator to produce two continuous video streams.

The exemplary gateway modulator (300) uses the circular buffer memory (320) to reduce the amount of memory required for buffering and to reduce the CPU load required to move the transport packets. When Ethernet packets are received they are automatically placed into a singular circular buffer memory (320) by the Ethernet DMA (310). The transport packets are left in the circular buffer memory (320) instead of copying them to a separate channel FIFO. A descriptor is created for each group of transport packets in a UDP packet. The descriptor indicates the memory location and the number of bytes of the transport packets in the circular buffer memory (320). These descriptors are then placed into a linked list FIFO. This permits the circular buffer memory (320) to be used for the jitter buffer for all channels. Since the maximum rate if a QAM 256 stream is 38.8 Mbps, the buffer memory requirements for 500 ms of buffer for 12 QAM streams is 29.1 MB or DDR memory. This also reduces the number of times the packets must be copied and reduces the microprocessor workload since the packets are not copied into separate channel FIFOs.

The Ethernet DMA (310) is operable to receive MPEG2 packets from the Ethernet network via an Ethernet port. The Ethernet DMA (310) reads UDP packets containing MPEG2 transport packets from the Ethernet MAC by using the receive DMA engine to copy the Ethernet packets to the circular buffer memory (320). The MPEG2 packets received represent multiple QAM streams, each of which may comprise multiple video channels. For example, an exemplary system may comprise 12 QAM streams each comprising 12 video channels. Thus, the Ethernet DMA may receive data representing 144 possible channels. The Ethernet DMA engine uses a linked list of pending DMA requests stored in a RAM block. The pending DMA requests place the packets into the circular memory buffer (320). Once DMA requests are finalized, the size of the Ethernet packet is remembered and the counter of how many packets in the circular memory buffer (320) is incremented. New DMA requests are added to the linked list of pending DMAs.

The circular buffer memory (320) accepts data from the Ethernet DMA (310). Data is stored in the order in which it is received from the Ethernet DMA (310). This results in a somewhat random order with regards to QAM stream and video channel. To identify the location of each packet stored in the circular buffer memory (320) a descriptor is created to identify the transport packet and its location in the circular buffer memory (320). The descriptor may indicate the memory location and the number of bytes of the transport packets in the circular buffer memory (320). This descriptor is then stored in a linked list. A linked list data structure can be implemented as a series of nodes, wherein each node contains two fields. The first filed of the node is the data identifying the transport packet and the second node is the link to the next node.

The microprocessor (340) uses the linked list to identify each transport packet and its location in the circular buffer memory (320). The microprocessor (340) then analyzes the next Ethernet packet in the circular buffer memory (320) to determine the packet type and place the MPEG2 transport packets into the correct link list. A video stream linked list may be created for each video stream. In the above exemplary embodiment, 144 link lists are generated, one for each of the 12 video streams in each of the 12 QAM streams. An exemplary method of operation comprises the following steps and configuration. Address resolution protocol (ARP) requests for the device's MAC address generate an ARP response. ARP reply responses let the device know the TRTP server's MAC address. Ping requests generate a ping reply. UDP packets with port 0×200-0×2ff are used to control the EdgeQAM and query its status. UDP packets with port QAMindex*16 +channelindex contain MPEG2 transport packets. Each MPEG transport packet is 188 bytes long. Up to seven MPEG2 transport packets are in each UDP packet. The MPEG2 transport packets are placed into linked lists. Each of the 144 possible channels has a linked list of MPEG 2 packets. There is a bitmap (12 bit integer) of which QAMstream has pending packets. Within a QAMstream there is a bitmap of which channels have pending packets.

After generating the video channel linked lists, the microprocessor (340) then checks each of the modulator buffers (345a-345x) to determine if any have space available and which linked lists have data. The microprocessor (340) then schedules a DMA request to the bus DMA (360) to request a transfer of data from the circular buffer memory (320) to the appropriate modulation buffer (345a-345x). In an exemplary embodiment of this request, a bitmap is generated of which FIFOs have space available. Each QAMstream is given a chance to schedule a DMA before the first QAMstream is analyzed again. Within a QAMstream each channel is given a chance to schedule a DMA before the first channel is analyzed again. Looping through the QAMstreams and channels prevents one QAMstream or channel from delaying the data from the other channels. The DMA requests go to a linked list of pending DMA requests. As the data is being transferred to the modulator buffers (345a-345x) via the bus (330) by the data bus DMA (360), the modulators (350a-x) extract the data from their respective modulator buffers (345a-345x) and generate a video data stream in a format and frequency appropriate for transmission on the cable network. The system according to the exemplary embodiment described above can transmit up to 144 possible channels simultaneously.

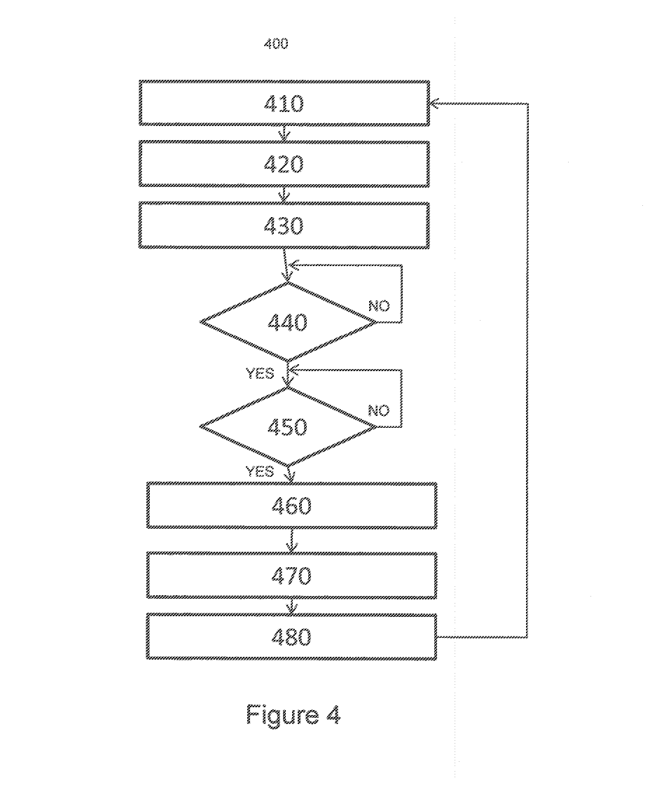

Turning now to FIG. 4, a flow chart illustrating a method (400) of buffer management technique according to the present invention is shown. The method first comprises the step of receiving a video data packet (410). The video packet can be received at an Ethernet MAC or a similar video input. Next the method uses an Ethernet receive DMA or the like, to store said video data packet to a memory (420). This memory may be a circular buffer memory, a FIFO or the like. Next, the method generates a linked list data entry (430) corresponding to a video channel comprising a location of said video data packet and an identifier of said video data packet. A microprocessor or system controller, then checks a linked list status corresponding to said video channel (440). If the linked list status indicates that there is data available, the microprocessor checks the status of a modulator buffer (450) or the like. The linked list status can be indicated by a flag or merely by the presence of data, or the presence of a linked list data node. If the linked list status indicates that no data is available, the microprocessor continues to check until data is available. The microprocessor may perform other operations in between checks, such as checking the linked list status of other video channels. After the microprocessor determines that data is available according to the linked list status, and the modulator buffer indicates that space is available, the microprocessor initiates a data transfer between the memory and the modulator buffer (460). If the modulator buffer indicates that no space is available, the microprocessor continues to check until space is available. The microprocessor may perform other operations in between checks, such as checking the modulator buffer status of other video channels. The data transfer between the memory and the modulator input memory may be performed by the microprocessor or by a DMA device. The method then comprises the steps of modulating the video data packet to generate a modulated video channel (470) and transmit said modulated video channel (480). Some or all of these steps may be performed simultaneously of different video data packets.

While the present invention has been described in terms of a specific embodiment, it will be appreciated that modifications may be made which will fall within the scope of the invention. For example, various processing steps may be implemented separately or combined, and may be implemented in general purpose or dedicated data processing hardware.

1. An video signal processing apparatus comprising:
an input processor for receiving a video data, said video data corresponding to a plurality of video channels;
a memory for storing said video data;
a plurality of linked lists, wherein each of said linked lists comprises at least one identifier and one location corresponding to at least one of said plurality of video channels;
a plurality of video modulators;
a controller for reading one of said plurality of linked lists, locating and identifying a portion of said video data corresponding to a single video channel in response to information from said one of said plurality of linked lists, and coupling said portion of said video data to one of said plurality of video modulators.

2. The video signal processing apparatus of claim 1 wherein said video data comprises a plurality of video streams, wherein each video stream comprises a plurality of video channels.

3. The video signal processing apparatus of claim 1 wherein said memory is a buffer for storing a plurality of video data;

4. The video signal processing apparatus of claim 3 wherein said memory is a common circular buffer.

5. The video signal processing apparatus of claim 1 wherein said memory is large enough to store 500 ms of each of said plurality of video channels.

6. The video signal processing apparatus of claim 1 wherein said portion of said video data is data corresponding to one of said plurality of video channels.

7. A method of processing video data comprising the steps of:
receiving data corresponding to a plurality of video channels;
storing said data;
generating a linked list wherein said link list identifies said data and a location of said data;
locating said data using information from said linked list;
identifying said data using information from said linked list;
coupling said data between a memory and a modulator;
modulating said data to generate a modulated video channel; and
transmitting said modulated video channel.

8. The method of processing video data of claim 7 wherein said data is stored in a common circular buffer.

9. The method of processing video data of claim 8 wherein said linked list indicates where said data is stored within said common circular buffer.

10. The method of processing video data of claim 7 wherein said common circular buffer is used to store at least 500 ms of video data for each of said plurality of video channels.

11. The method of processing video data of claim 7 wherein said coupling step further involves the steps of
determining whether said data is available to couple to said modulator; and
determining whether said modulator is ready for said data.

12. The method of claim 1 wherein said data is received via Ethernet.

13. The method of claim 1 wherein said modulated video channel is transmitted via a cable network.

14. A video processing apparatus comprising:
a plurality of inputs for receiving a plurality of video signals;
a processor for converting said plurality of video signals into a plurality of packetized video signals;
a memory for storing said plurality of packetized video signals;
a linked list for identifying and locating each of said plurality of packetized video signals;
a controller for using said linked list to couple one of said packetized video signals to a modulator to generate a modulated video signal; and
an output for transmitting said modulated video signal.

15. The video processing apparatus of claim 14 wherein said plurality of video signals are satellite signals and said plurality of packetized video signals are formatted to be transported on an Ethernet network.

16. The video processing apparatus of claim 14 wherein said memory is a common circular buffer.

17. The video processing apparatus of claim 16 wherein said memory is large enough to store 500 ms of video for each of said plurality of packetized video signals.

18. The video processing apparatus of claim 14 wherein said one of said packetized video signals comprises data corresponding to one video channels.

19. The video processing apparatus of claim 14 further comprising a plurality of modulators, each modulator operative to modulate one of said plurality of packetized video signals.

20. The video processing apparatus of claim 14 wherein said output is operative to transmit a plurality of modulated video signals.
